(19) United States
(12) Patent Application Publication
(10) Pub. No.: US 2011/0213804 A1
(43) Pub. Date: Sep. 1, 2011

(54) SYSTEM FOR EXTRACTING RALATION BETWEEN TECHNICAL TERMS IN LARGE COLLECTION USING A VERB-BASED PATTERN

(75) Inventors: Min Ho Lee, Daejeon (KR); Yun Soo Choi, Daejeon (KR); Sung Pil Choi, Daejeon (KR); Nam Gyu Kang, Daejeon (KR); Kwang Young Kim, Cheonan-si (KR); Han Gee Kim, Daejeon (KR); Chang Hoo Jeong, Daejeon (KR); Min Hee Cho, Daejeon (KR); Hwa Mook Yoon, Daejeon (KR)

(73) Assignee: KOREA INSTITUTE OF SCIENCE & TECHNOLOGY INFORMATION, Daejeon (KR)

(21) Appl. No.: 13/127,011

(22) PCT Filed: Dec. 15, 2008
(86) PCT No.: PCT/KR2008/007423

§ 371 Date: Apr. 29, 2011

(30) Foreign Application Priority Data
Nov. 14, 2008 (KR) 10-2008-0113564

(51) Int. Cl. G06F 17/30

(52) U.S. Cl. 707/776; 707/E17.022

(57) ABSTRACT

Disclosed herein is a system structure for extracting relations between technical terms within a large amount of literature information using verb-based patterns. The present invention provides a system that is capable of extracting relations based on verb-based patterns from abstract and bibliography databases in all fields of science and technology using a Tech Association Mining Appliance (TAMA) capable of detecting the technical terms of text and relations therebetween in academic literature databases in the fields of science and technology. The present invention has an advantage of providing a practical relation extraction system structure using a number of academic databases.

### TECHNICAL FIELD

The present invention relates generally to a system structure for extracting relations between technical terms within a large amount of literature information using verb-based patterns, and, more particularly, to a system for extracting relations between technical terms within a large amount of literature information using verb-based patterns, which is capable of extracting relations based on verb-based patterns from abstract and bibliography databases in all fields of science and technology using a Tech Association Mining Appliance (TAMA) capable of detecting the technical terms of text and relations therebetween in academic literature databases in the fields of science and technology.

### BACKGROUND ART

Recently, in the fields of natural language processing and text mining, which is a technique for finding an interesting or useful pattern in unstructured text information data, information extraction is considered a core field. Information extraction generally includes three elemental techniques: coreference resolution, named-entity recognition and relation extraction. The ultimate object of information extraction is to detect important and associated information in data streams in order to convert irregular data into tabled and regular data. Of the above-described three elemental techniques of information extraction, relation extraction has been considered an unsolved field having the highest degree of difficulty.

The final results of relation extraction may be considered, in a broad sense, a semantic relational network between associated entities which spreads over the entire set of text documents. In other words, there is no limiting condition on the distance concerning the extraction of relations between entities. A higher-order relation extraction scheme capable of directly extracting relations between three or more entities may also be considered. However, so far, binary relation extraction between two entities existing within a single sentence has been generally performed. With regard to another characteristic of the technology in this field, most conventional techniques are configured to attempt relation extraction for only semantic relations between general entity names (names of people, place names, firm names, etc.), but technology for extracting relations between a variety of major keywords or technical terms existing in specialized fields, such as the fields of science and technology, has not yet been developed. Of course, in the field of biological information science, the construction and use of a field ontology, the development of a technology for relation extraction, and its applications have been actively performed in developing technology for various specific elements, such as protein interactions, DNA sequencing, and the estimation of relations between the terminologies of a biological field.

The history of the technological development pertinent to this relation extraction may be considered to be very long. In particular, attempts to automatically or semi-automatically establish a thesaurus, a semantic network, an ontology, etc., which are considered to be very important in literature information science or computational linguistics, have been very actively made. However, this technological development has for the most part focused on research into the same type of single relation extraction, such as, chiefly, ‘is-a’ and ‘part-of’ or, rarely, ‘caused-by’. This single relation automatically extracted as described above is often used to enhance the performance of information searches.

Meanwhile, with the rapidly increasing volume of web documents, the development of a technology for extracting relations using the web is very actively performed. Technology for extracting binary relations between specific books and the books' authors in a web has been developed. Attempts to automatically or semi-automatically extract various forms of entities, expressed in web documents, and relations between the entities have been very actively made.

One of the important characteristics of the web-based relation extraction schemes is that they use an incremental boosting technique for, while basically adopting a machine learning model, gradually boosting the machine learning model using nucleus seed lexical patterns. The machine learning model basically requires learning sets and verification sets. The above-described schemes are chiefly used because it is very difficult to collect and establish learning/verification collections for processing open and variable web documents. The most problematic portion is however performance evaluation of a system. In most technological developments to date, this performance evaluation is performed using the manual verification of results through sample extraction.

In the development of a technology for a supervised relation extraction scheme using the machine learning scheme, the learning sets for machine learning-based relation extraction were totally provided by the “Template Relation Extraction” task which was first introduced in the Message Understanding Conference, 1997 (MUC-7), thereby providing a basis for the development of technology in this field. The highest performance disclosed at that time was about 75% on the basis of F-measure.

With the rapid development of the computing ability and the stabilization of language processing-based technology, technology for relation extraction was provided with an opportunity for staging new development. A project that accelerated the flow of this technological development includes the Automatic Content Extraction (ACE) of the National Institute of Standards and Technology (NIST). In line with the successful results of the MUC-7, the NIST and the Defense Advanced Research Projects Agency (DARPA) actively attempted to establish an infrastructure for a higher-order information extraction scheme. As a result of these attempts, ACE verification collections were established every year, and workshops have been held based on research made by many researchers based on the ACE verification collections. Learning sets that have been open to the public so far are versions established during the years 2002 to 2005, and are distributed through the Linguistic Data Consortium (LDC).

The development of technology for full-supervised relation extraction based on the disclosed ACE collections is being partially performed, and technically important developmental content is being made public. Meanwhile, a kernel-based machine learning model that has now totally emerged since being started in the year 2000 has started to be applied to relation extraction technology. The kernel model that exhibits very excellent natural language processing performance, such as document classification and named-entity recognition, has received good evaluations in terms of efficiency and accuracy. The kernel model is however problematic in that it necessarily requires reliable learning sets because the kernel model is limited to only the supervised learning scheme. Furthermore, in relation extraction, useful quality must be extracted from only a single sentence, including two or more entities, or the surrounding context and the extracted quality must be used, unlike in the classification of documents (a single pattern=a single document), having a high possibility that useful quality can be extracted because the volume of an individual subject pattern is relatively large. Accordingly, the kernel model inevitably has a very high degree of difficulty in terms of learning.

### DISCLOSURE

### Technical Problem

As described above, most technological developments for relation extraction which have been performed so far have had the severe limitations of being limited to entities which are the objects of its relation, and also being limited to target relations. It proves that the level of technological development in this field is in the early stage and that an examination of various application services using the results of relation extraction has fallen short.

The present invention has been made keeping in mind the above problems occurring in the prior art, and an object of the present invention is to provide a system for extracting relations between technical terms within a large amount of literature using verb-based patterns, which is capable of extracting relations based on verb-based patterns from abstract and bibliography databases for all fields of science and technology by using a TAMA capable of detecting technical terms included in text and relations therebetween for academic literature databases in the fields of science and technology so that tens of thousands of technical terms appearing in academic databases over all the fields of science and technology can be detected and relations therebetween can be extracted.

### Technical Solution

In order to achieve the above object, the present invention provides a system for extracting relations between technical terms within a large amount of literature information using verb-based patterns in a Scientific Tech Mining (STM) system for performing in-depth analysis of articles, patents and other academic data in scientific and technological fields through a combination of text mining technology and information analysis technology, the STM system comprising a TAS (technical term recognition system) for processing original databases and searching and attempting to match hundreds of thousands of technical term dictionaries; a TRS (technical research management system) for loading, systematically managing, and servicing overall data of the technical terms which have been recognized by the TAS means; an Integrated Information & Function Provider (IIFP) for supporting systematic access to precisely processed high-capacity databases, the IIFP being a backbone system; a Tech Association Mining Appliance (TAMA) for systematically and multilaterally extracting and verifying relations between technical terms of sentences, including a number of technical terms, using an academic database access API of the IIFP; and a Semi-Automatic Tech-Tracking engine (SATT) connected to the IIPF and configured to be responsible for a variety of services using triple sets obtained as outputs of the TAMA and the academic database access API processed by the IIFP, wherein the TAMA comprises a Target Relation Determiner (TRD) configured to, when sentences extracted from the databases are received, perform a detailed analysis process on each of the sentences using the IIFP and to, when candidate relation sets are created based on conceptualized lexical clues, that is, based on nucleus words which play a crucial role in expressing relations, perform a task for determining nucleus relations selected from among the candidate relations, and Semi-Supervised RElation Extraction (SSREE) means and Supervised RElation Extraction (SREE) means configured to be driven when final target relations are determined by the TRD and all preparations for substantial relation extraction are made.

the TRD includes a lexical clue acquisition function of detecting, extracting and purifying lexicons that vitally describe relations between technical terms, and a lexical clue conceptualization function of abstracting and semantically clustering lexical clues acquired using WordNet.

The SSREE means continuously extracts relations for new sentences without requiring separate learning sets if rule sets capable of extending lexical clues and sentence patterns exist.

The TRD creates and provides a variety of lexical clue sets which are necessary to drive the SSREE means.

The SREE means necessarily requires learning sets, requires a lot of manual tasks for the learning sets, and uses the relation extraction results of the SSREE means as its learning sets.

Final outputs of the TAMA are chiefly divided into two types of result triples, that is, a Concrete Relation Triple (CRT) and an Abstract Relation Triple (ART), depending on a conceptualization degree of relations.

In the CRT, relations between technical names are very concrete and are mapped to hypernym verb synsets of WordNet.

The CRT may have relations, such as (change, alter, modify), (act, move), (transfer), and (make, create).

In the ART, relations between technical names are abstract, are mapped at the level of the semantic classification of verbs, and are mapped to the verb concept classification system of WordNet.

The ART may have relations, such as “change,” “cognition,” “competition,” “contact,” “creation,” “motion,” “possession,” “communication,” “perception,” and “state.”

### Advantageous Effects

The present invention differs from conventional technologies in that it attempts to develop a technology for determining how relations between technical and specialized terms (specialized terms) widely used in the science and technology fields will be extracted using the technical terms as entities. Furthermore, the present invention is advantageous in that it provides a practical relation extraction system structure using lots of academic databases, unlike a conventional access method of extracting only a small number of relations on the basis of a limited number of collections and entities.

### DESCRIPTION OF DRAWINGS

FIG. 1 is a block diagram schematically showing the construction of a Scientific Tech Mining (STM) system according to the present invention;

FIG. 2 is a block diagram schematically showing the construction of a TAMA that functions as an element module of the STM system;

FIG. 3 is a block diagram schematically showing a detailed step of conceptualizing verb phrases according to the present invention;

FIG. 4 is a diagram schematically showing a concept mapping scheme based on transference to hypernyms according to the present invention; and

FIG. 5 is a diagram showing mapping results, listed in Table 6, in the form of a graph.

### DESCRIPTION OF REFERENCE NUMERALS OF PRINCIPAL ELEMENTS IN THE DRAWINGS

| | |
|---|---|
| 100: STM system | 110a,b,c: TRS |
| 120a, 120b, 130a, 130b, 130c, and 140: literature | |
| 150: TAS | 160: SATT |
| 162: TABS | 164: MIS |
| 170: TAMA | 172: CREM |
| 174: AREM | 180: TLA |
| 190: IIFP | 200: TRD |
| 210: CRT | 220: SSREE module |
| 230: SREE module | 240: ART |

### MODE FOR INVENTION

The terms and words used in the present specification and the accompanying claims should not be limitedly interpreted as having common meanings or those found in a dictionary, but should be interpreted as having meanings suitable for the technical spirit of the present invention on the basis of the principle in which an inventor can appropriately define the concepts of terms in order to describe his or her invention in the best way.

The present invention will now be described with reference to the accompanying drawings.

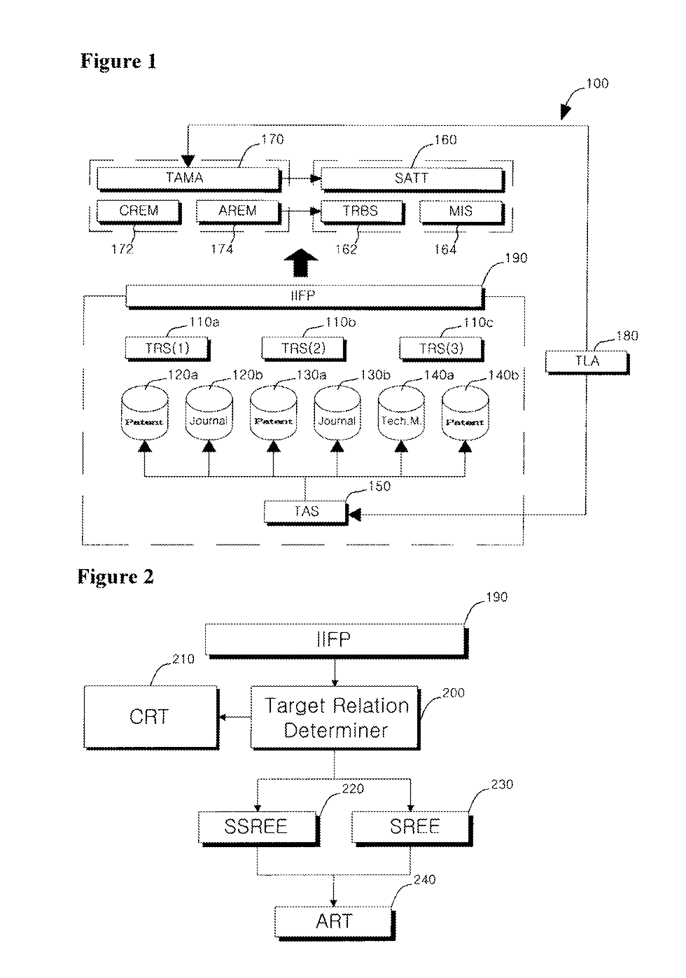

FIG. 1 is a block diagram schematically showing the construction of an STM system according to the present invention.

Referring to FIG. 1, the STM system 100 is a new concept-based system for the analysis of scientific and technological knowledge, which is capable of, in depth, analyzing the articles of the fields of science and technology, patents, and other academic data through a combination of text mining technology and information analysis technology. A conventional tech mining concept was proposed by Alan L. Poter of Search Technology Inc., which was famous for an analysis tool called ‘Vantage Point,’ in 2004. The STM system 100 has been developed as a more specific and user-friendly specialized knowledge analysis tool for the fields of science and technology using further in-depth technology (language processing technology, machine learning technology, etc.) on the basis of this concept.

A TAS (technical term recognition system) 150, constituting part of the STM system 100, processes original databases and searches or attempts to match the 243,575 technical term dictionaries of 16 fields. That is, the TAS 150 performs the tagging of parts of speech and the tagging of phrases and clauses for the original database through a Tech Language Analyzer (TLA) 180. In this process, a variety of special rules or algorithms for solving lexical deformation and for processing compound words are used. The TAS 150 may use an automatic technical term extraction system which can automatically detect unregistered terms that do not exist in the dictionaries.

A TRS (technical research management system) 110 loads, systematically manages, and services all the technical terms which have been detected by the TAS 150. The TRS 110 is a system configured to perform an in-depth search for technical terms, and is an extension of the functionality of a general search engine. The TRS 110 and the TAS 150 perform the functions of an Integrated Information & Function Provider (IIFP) 190 for S™. The IIFP 190 is a backbone system, constituting part of the STM system 100, and is configured to support systematic access to precisely processed high-capacity databases.

A TAMA 170 and a Semi-Automatic Tech-Tracking engine (SATT) 160 are connected to the IIFP 190. The SATT 160 is a module responsible for substantial services, and constructs various types of services using triple sets (technical terms, relations, and technical terms) provided through the outputs of the TAMA 170 and an academic database access API processed by the IIFP 190.

FIG. 2 is a block diagram schematically showing the construction of the TAMA that functions as an element module of the STM system.

Referring to FIG. 2, the TAMA 170 extracts sentences, including a number of technical terms, using the access API of the IIFP 190. The sentences extracted using the IIFP 190 are applied to a Target Relation Determiner (TRD) 200. The TRD 200 performs an in-depth analysis process on a sentence basis. The TRD 200 includes a lexical clue acquisition function and a lexical clue conceptualization function. The lexical clue acquisition function is a function of detecting, extracting and purifying lexicons that vitally describe relations between technical terms. The lexical clue conceptualization function is a function of abstracting and semantically clustering lexical clues acquired using WordNet, etc. The term ‘lexical clue’ refers to a nucleus word that plays a crucial role in the expression of relations. In the present invention, a task is performed on the basis of verbs and verb equivalents, that is, lexical clues of relation which are intuitively the clearest ones in the early stage.

When candidate relation sets are created based on the lexical clues conceptualized by the TRD 200, a task to determine nucleus relations selected from among the candidate relations must be performed. When final target relations are determined by the TRD 200 and all preparations for relation extraction are substantially made, a Semi-Supervised RElation Extraction (SSREE) module 220 and A Supervised RElation Extraction (SREE) module 230, placed under the TRD 200, are driven.

The SSREE module 220 does not need separate learning sets. If there are rule sets capable of extending lexical clues and sentence patterns, the SSREE module 220 can continuously perform relation extraction for new sentences, so the SSREE module 220 is naturally configured. The TRD 200 creates and provides a variety of lexical clue sets necessary to drive the SSREE module 220. Here, relation extraction may be performed by establishing and extending lexicons and grammar rule sets for extracting relation expressions in sentences.

The SREE module 230 necessarily requires learning sets, requires a lot of manual tasks for the learning sets, and uses the relation extraction results of the SSREE module 220 as its learning sets.

The final outputs of the TAMA 170 are chiefly divided into two types of result triples, that is, a Concrete Relation Triple (CRT) 210 and an Abstract Relation Triple (ART) 240, depending on the conceptualization degree of the relations. In the CRT 210, relations between technical names are very concrete and are mapped to verb synsets which are the hypernyms of WordNet. The CRT 210 may have relations, such as (change, alter, modify), (act, move), (make, create), and (transfer).

In the ART 220, relations between technical names are abstract, are mapped at the level of the semantic classification of verbs, and are mapped to the verb concept classification systems of WordNet. The ART 220 may have relations, such as “change,” “cognition,” “competition,” “contact,” “creation,” “motion,” “possession,” “communication,” “perception,” and “state.”

The reason why the result triples of the TAMA 170 are divided into the two types is to support the diversity of external application services using the triples. Browsing service or keyword extension service depending on very in-depth relations between technical terms may be required depending on the circumstances. In-depth application services, such as reasoning, extension and transference, may be required based on relations that are somewhat abstract. For higher-order semantic-based services, a result triple in which the above two types are combined together may be required.

In the present invention, since WordNet has been used in order to conceptualize lexicons using clues that are chiefly verbs, the types of conceptualized relations vary depending on the positions where the lexical clues are mapped in WordNet.

As can be seen from the above description, the CRT 210 has attempted mapping for a total of 13,767 in-depth verb synsets existing in the WordNet, and the expression concepts thereof are detailed and concrete. In contrast, the ART 220 has attempted mapping for a 15-verb concept class system provided by WordNet, and the expression concepts thereof are relatively abstract.

Assuming that the final target of the TRD 200 is a base preparation task for selecting the most important and comprehensive nucleus relations from among relations between technical terms expressed in current academic databases and for totally extracting the nucleus relations, all lexical clues detected and conceptualized by the TRD 200 need not be target relations. If candidate relations are created as the result of the present invention, the experts of information service, natural language processing, information searching and knowledge engineering can select relations suitable for applications from among the created candidate relations.

As an embodiment, relation extraction based on a basic sentence pattern is described below.

As part of basic research, relations between technical terms are extracted from sentences, each having a relatively simple form, based on the construction of the TAMA 170 shown in FIG. 2. Although from the viewpoint of the overall workflow or the independence of the individual modules of the STM system 100, it has low direct association with the TAMA 170, statistical information for original data is shown in the following table 1 for reference.

TABLE 1

| ITEM | VOLUME (CASES) | SIZE (GB) |
|---|---|---|
| total number of | 30,858,830 (100.0%) | 16.0 |
| documents | | |
| (bibliography) | | |
| number of | 12,666,438 (42.9%) | 8.0 |
| bibliographical | | |
| cases including | | |
| abstracts | | |
| number of | 18,192,392 (57.1%) | 8.0 |
| bibliographical | | |
| cases not including | | |
| abstracts | | |

The total volume of the academic databases was 30 million cases or more, but tasks were performed only on bibliographical documents, including abstracts, in the light of quality extraction and sentence extraction tasks for relation extraction. The TRD 200 extracted sentences, including technical terms having three basic types expressed in Table 2, using the access API of the IIFP 190.

TABLE 2

| BASIC TYPES OF SENTENCES | |
|---|---|
| INCLUIDNG TWO | |
| TECHNICAL TERMS | NUMBER OF SENTENCES |
| technical term (NP) + verb | 2,752,193 |
| phrase (VP) + technical term | |
| (NP) | |
| technical term (NP) + verb | 3,646,484 |
| phrase (VP) + preposition (PP) + | |
| technical term (NP) | |
| technical term (NP) + verb | 111,740 |
| phrase (VP) + adverb (ADJP) + | |
| preposition (PP) + technical | |
| term (NP) | |

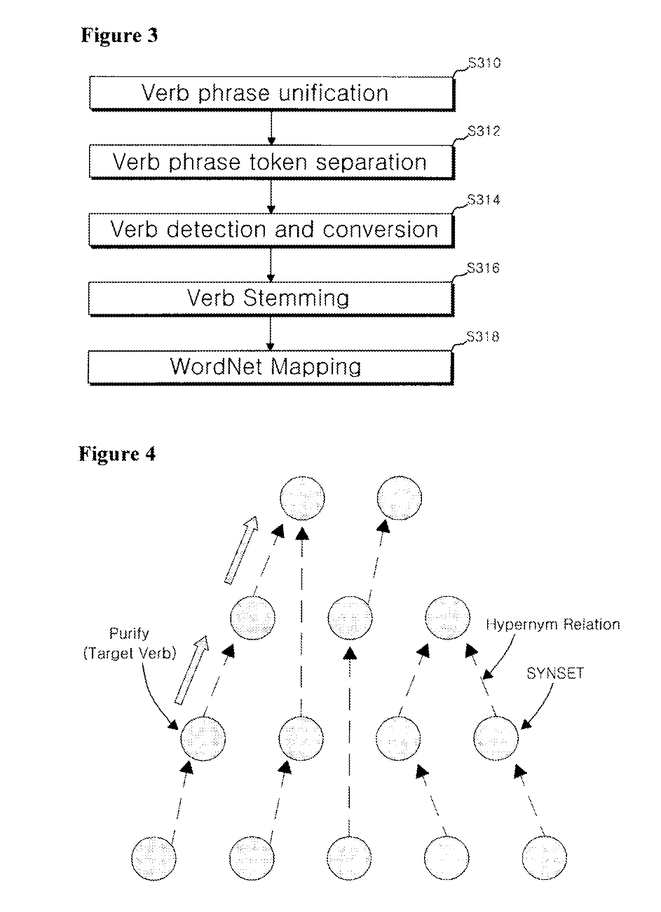

In the present invention, analysis (a basic task for relation extraction) is performed on sentences of the first type, that is, the simplest of the above three types. The reason why the task is first performed for sentences having the first type is that, as a result of manually analyzing the structures of sentence sets representing binary relations, about 10% of the structures were expressed by the first type of sentence structure. A task of unifying and regularizing verb phrases, variously expressed between two technical terms, based on the results and then mapping the unified and regularized results to WordNet is performed. A detailed process for the above task is shown in FIG. 3.

FIG. 3 is a block diagram schematically showing a detailed step of conceptualizing verb phrases according to the present invention.

Referring to FIG. 3, the verb phrase conceptualization step includes a total of five detailed processes. A verb phrase unification step S310 refers to a simple unification task for verb phrases that repeatedly appear. A verb phrase token separation step S312 is a token separation task for verb phrases including multi-word phrases, such as “has been moved,” and “was executed.” In a verb detection and conversion step S314, that is, a third step, (1) the conversion of verbs, expressed in the passive voice, into the active voice (that is, passive voice conversion), (2) the conversion of present/past perfect tenses, (3) the filtering of verb phrases, including adjective and adverbs, because of chunking error or tagging error in parts of speech (that is, the removal of adjectives, adverbs (˜ly, to)), and (4) filtering such as the removal of conjunctions are performed. A substantial WordNet mapping step S318 is performed using Java WordNet Interface (JWI) 2.1.4 which was developed by MIT.

FIG. 4 is a diagram schematically showing a concept mapping scheme transference to hypernyms according to the present invention.

Referring to FIG. 4, synset sets constituting part of the WordNet are connected to each other on the basis of various relations. In the present invention, in order to connect specific verbs to synsets having as comprehensive concepts as possible when synset mapping for the verbs is attempted, a concept mapping scheme based on automatic transference to hypernyms is employed using the hypernym relations shown in this drawing.

The greatest reason why transference to the hypernyms is attempted is to reduce diversity by generalizing concepts expressed by specific verbs as much as possible and to ensure a locality in determining nucleus relations and extracting relations for new sentences based on the reduced diversity. As described above, most technological developments pertinent to relation extraction which have been performed so far have been focused on at least one or two (web-based SSRE) to a maximum of 24 (SRE and ACE collections) relations. Accordingly, even in the present invention, experts are empowered to select several types of relations which are frequently and significantly expressed in data and coincide with the knowledge service of the STM system 100, rather than accommodating excessive types of relations, in the task of determining nucleus relations.

TABLE 3

| ITEM | NUMBER | PERCENTAGE (%) |
|---|---|---|
| total of verb phrase | 2,752,193 | 100.00 |
| sets | | |
| total of unified verb | 2,049,898 | 74.50 |
| phrase sets | | |
| verb sets after third | 4,514 | 0.164 |
| conceptualization step | | |
| verb sets which belong | 4,495 (99.58%) | 0.163 |
| to the 4,514 and were | | |
| successfully mapped to | | |
| WordNet synsets | | |
| verb sets which belong | 19 (0.42%) | |
| to the 4,514 and were | | |
| unsuccessfully mapped to | | |
| WordNet synsets | | |

Table 3 shows the results of WordNet mapping for verb conceptualization. From Table 3, it can be seen that the number of verbs after the verb detection and conversion step of the verb phrase conceptualization step of FIG. 3 had been performed abruptly decreased, that is, to 0.16% of the existing number of verbs. From the above results, it can be seen that the types of verbs which can express relations between technical terms in scientific and technological literature is greatly limited, and there is a high possibility that the types of verbs can be used as basic resources which can be used to automatically extract relations between technical terms by accurately analyzing the types of verbs over a long time. As a result of the mapping task for the verb synsets of WordNet based on the 4,514 verb sets on which the third conceptualization step was performed, 4,495 verbs, that is, about 99.6% of the entire verbs, were mapped as in the fourth row of Table 3. As a result of analyzing the unsuccessful 19 verbs, it was found that most of the verbs were new words not existing in WordNet or were the result of verb recognition error caused by language analysis error.

TABLE 4

| ITEM | NUMBER | PERCENTAGE (%) |
|---|---|---|
| mapped verbs | 4,495 | — |
| mapped WordNet | 497 | 4.31 |
| synsets | | |
| total WordNet verb | 13,767 | 100.00 |
| synsets | | |

Table 4 shows a mapping coverage for verb synsets and also the percentage of mapped WordNet synsets in all the WordNet verb synsets.

From Table 4, it can be seen that only 497 synsets, that is, 4.31% of the entire 13,767 verb synsets, were locally mapped. It reveals that verbs, expressing relations between technical terms, have a semantic locality as well as the morphological locality shown in Table 3.

A scheme for overcoming vagueness which is generated when mapping is performed has not been applied to the WordNet mapping task that has been performed so far. There is a high possibility that one verb may be mapped to two or more synsets, and this possibility is actually generated. Tables 3 and 4 include numerical values including this multi-mapping. However, the above results provide the following meanings regardless of the multi-mapping problem.

First, the morphological locality of a verb that connects two technical terms is very high, and the hit rate of mapping to WordNet is also very high. It is meant that a relation between the technical terms shares the same semantic space as that of a relation between general entity names or concepts.

Second, although the relation conceptualization task was performed on a large number of about 2.70 million sentence sets including technical terms, a small number of 497 concepts were localized. It is expected that the number of concepts could be further reduced through additional analysis and an improved model task.

Third, it can be seen that verbs are gathered around 4.31% (497) of all the synsets even though multi-mapping was performed. It is expected that, if a vagueness removal algorithm is applied in the future, this gathering phenomenon will become more profound. In this case, locality is increased in terms of objectivity when substantial target relations are determined or in terms of a relation estimation task for new sentences after relations have been determined. It may lead to improved performance.

TABLE 5

| VERB MEANING CLASS | EXEMPLARY VERBS (VERBS) |
|---|---|
| body: body function and | sweat, shiver, faint |
| treatment | |
| change: change | change |
| cognition: congnition | deduce, induce, infer |
| communication: communication | lisp, stammer, babble |
| competition: competition | referee, handicap, campaign |
| consumption: consumption | drink, eat |
| contact: contact | rub, cut, cover |
| creation: creation | invent, print, weave |
| emotion: emotion/mentality | fear, miss, charm |
| motion: motion | gallop, race, taxi |
| perception: perception | see, stare, smell |
| possession: possession | have, give, take |
| social: social interaction | impeach, court-martial |
| state: state | equal, suffice, lack |
| weather: weather | rain, thunder, snow |

Table 5 shows the classification of WordNet verb meanings. The WordNet includes a total of 15 pieces of verb meaning classification information internally, and Table 5 shows details for the classification information of WordNet.

The above classification information of verb meanings is indicated as additional information in all the synsets existing in WordNet and therefore can be performed simultaneously with a verb synset mapping task. In other words, after a pertinent synset is mapped to a specific verb, meaning classification information can also be automatically extracted.

TABLE 6

| | NUMBER OF | |
|---|---|---|
| | MAPPED | |
| VERB MEANING CLASS | VERBS | PECENTAGE (%) |
| body: body fucntion | 547 | 12.12 |
| and treatment | | |
| change: change | 2,567 | 56.87 |
| cognition: cognition | 935 | 20.71 |
| communication: | 1,643 | 36.40 |
| communiction | | |
| competition: | 402 | 8.91 |
| competitioin | | |
| consumption: | 244 | 5.41 |
| consumption | | |
| contact: contact | 2,148 | 47.59 |
| creation: creation | 692 | 15.33 |
| emotion: | 354 | 7.84 |
| emotion/mentality | | |
| motion: motion | 1,330 | 29.46 |
| perception: | 448 | 9.92 |
| perception | | |
| possession: | 846 | 18.74 |
| prossession | | |
| social: social | 1,227 | 27.18 |
| interaction | | |
| state: state | 936 | 20.74 |
| weather: weather | 77 | 1.71 |
| sum | 14,396 | 318.93 |

Table 6 shows the results of WordNet verb meaning classification mapping and also the results of verb meaning classification mapping for the verbs (4,495) mapped to the WordNet synsets of Table 3. This table also shows that one verb was mapped to several meaning classes because multi-mapping processing had not been performed. From the lowest row of Table 6, it can be seen that the sum of all the percentages, that is, 318.93%, refers to that one verb is mapped to three or more verb classes.

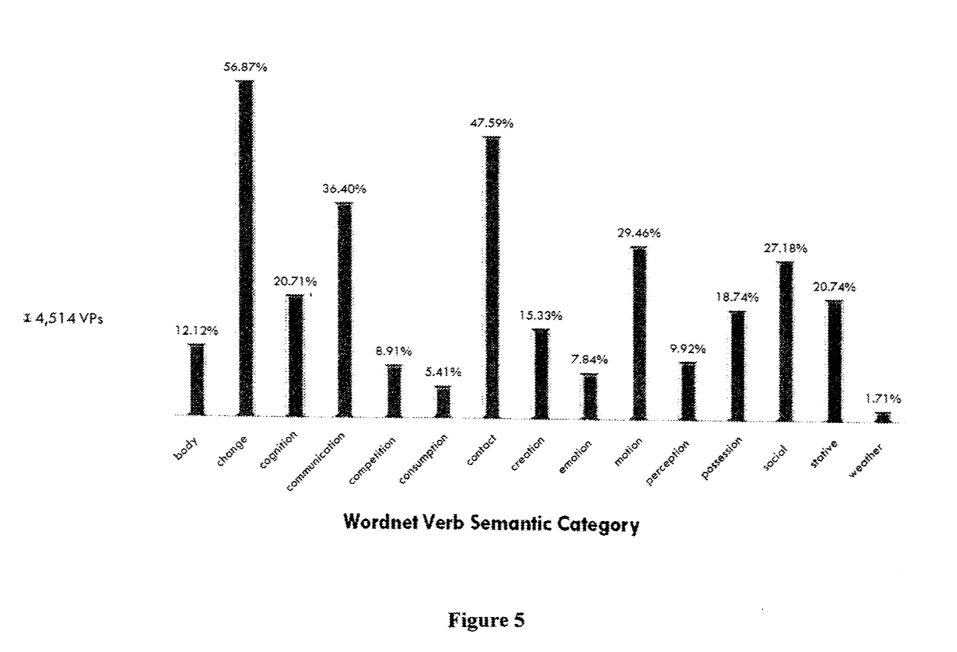

FIG. 5 is a diagram showing the mapping results, listed in Table 6, in the form of a graph.

With reference to FIG. 5, it can be seen that, as a result of mapping the 4,514 verbs, mapping to verb meaning classes, such as “change,” “communication,” “contact,” “motion,” and “social interaction,” is very frequently performed. In other words, it may be estimated that relations between technical terms within academic databases are expressed frequently using the above five types of concepts. As described above with reference to the WordNet synset mapping for verbs, it is considered that the above locality phenomenon will become clearer if vagueness in the mapping process is removed. Of course, different results may be output through the in-depth analysis of different sentence patterns or hidden composite sequences. In the present invention, however, in order to minimize a change in results depending on the access method, tasks were performed on high-capacity databases from the beginning.

As can be seen from the above description, according to the present invention, when technical terms expressed in high-capacity academic databases and relations therebetween are extracted from the databases, verb phrases that connect 2,752,193 technical terms are processed in depth and 4,514 unified verbs are extracted, using the TRD for determining nucleus target relations, which belongs to those detailed modules of the TAMA which are for systematically and multilaterally extracting and verifying relations between technical terms. About 95.6% of the 4,514 extracted verbs, that is, about 4,495 verbs, are conceptualized as 495 types of synsets by mapping the 4,514 extracted verbs to the verb synsets of WordNet. The 495 types of synsets are again mapped to the verb meaning classes of WordNet. Accordingly, it can be seen that verbs, which express the relations between the technical terms, are greatly limited and condensed morphologically or semantically. Nucleus target relations are determined using the verbs and relations between all the technical terms.

As described above, the most important function of the TRD, that is, the element module of the TAMA, is to prepare a base for determining nucleus target relations. Furthermore, the two types of triples (CRT and ART) obtained during this target relation determination process are provided to the remaining modules of the TAMA. Accordingly, the triples can function as knowledge base creators which are necessary to develop new experimental information services.

Although only the embodiments of the present invention have been described in detail, those skilled in the art will appreciate that various modifications and changes are possible, without departing from the scope and spirit of the invention as disclosed in the accompanying claims.

1. A system for extracting relations between technical terms within a large amount of literature information using verb-based patterns in a Scientific Tech Mining (STM) system for performing in-depth analysis of articles, patents and other academic data in scientific and technological fields through a combination of text mining technology and information analysis technology, the STM system comprising a TAS (technical term recognition system) for processing original databases and searching and attempting to match hundreds of thousands of technical term dictionaries; a TRS (technical research management system) for loading, systematically managing, and servicing overall data of the technical terms which have been recognized by the TAS means; an Integrated Information & Function Provider (IIFP) for supporting systematic access to precisely processed high-capacity databases, the IIFP being a backbone system; a Tech Association Mining Appliance (TAMA) for systematically and multilaterally extracting and verifying relations between technical terms of sentences, including a number of technical terms, using an academic database access API of the IIFP; and a Semi-Automatic Tech-Tracking engine (SATT) connected to the IIPF and configured to be responsible for a variety of services using triple sets obtained as outputs of the TAMA and the academic database access API processed by the IIFP,
wherein the TAMA comprises a Target Relation Determiner (TRD) configured to, when sentences extracted from the databases are received, perform a detailed analysis process on each of the sentences using the IIFP and to, when candidate relation sets are created based on conceptualized lexical clues, that is, based on nucleus words which play a crucial role in expressing relations, perform a task for determining nucleus relations selected from among the candidate relations, and Semi-Supervised RElation Extraction (SSREE) means and Supervised RElation Extraction (SREE) means configured to be driven when final target relations are determined by the TRD and all preparations for substantial relation extraction are made.

2. The system according to claim 1, wherein the SATT configures various types of services using the processed academic database access API provided by the IIFP and triple sets (technical terms, relations and technical terms) provided as outputs of the TAMA.

3. The system according to claim 2, wherein the TAMA extracts sentences, including a number of technical terms, using the access API of the IIFP.

4. The system according to claim 1, wherein the TRD comprises a lexical clue acquisition function of detecting, extracting and purifying lexicons that vitally describe relations between technical terms, and a lexical clue conceptualization function of abstracting and semantically clustering lexical clues acquired using WordNet.

5. The system according to claim 4, wherein the relations include mapping lexicon words to synsets and extracting a root synset as a relation.

6. The system according to claim 1, wherein the TRD creates and provides a variety of lexical clue sets which are necessary to drive the SSREE means.

7. The system according to claim 6, wherein the SSREE means continuously extracts relations for new sentences without requiring separate learning sets if rule sets capable of extending lexical clues and sentence patterns exist.

8. The system according to claim 7, wherein the SREE means necessarily requires learning sets, requires a lot of manual tasks for the learning sets, and uses the relation extraction results of the SSREE means as its learning sets.

9. The system according to claim 1, wherein final outputs of the TAMA are chiefly divided into two types of result triples, that is, a Concrete Relation Triple (CRT) and an Abstract Relation Triple (ART), depending on a conceptualization degree of relations.

10. The system according to claim 9, wherein, in the CRT, relations between technical names are very concrete and are mapped to hypernym verb synsets of WordNet.

11. The system according to claim 9, wherein, in the ART, relations between technical names are abstract, are mapped at a level of semantic classification of verbs, and are mapped to a verb concept classification system of WordNet.
